(19) United States
(12) Patent Application Publication
(10) Pub. No.: US 2021/0032869 A1
(43) Pub. Date: Feb. 4, 2021

(54) ARTICULATED ARM STRUCTURE FOR AN AWNING WITH AN INTEGRATED ELECTRICAL INSTALLATION

(71) Applicant: GAVIOTA SIMBAC, S.L., Sax (Alicante) (ES)

(72) Inventors: Francisco Vicente GUILLEN CHICO, Sax (Alicante) (ES); Ignacio BALLESTER PÉREZ, Sax (Alicante) (ES); Sergio SÁNCHEZ GUERRA, Sax (Alicante) (ES)

(73) Assignee: GAVIOTA SIMBAC, S.L., Sax (Alicante) (ES)

(21) Appl. No.: 16/941,790

(22) Filed: Jul. 29, 2020

(30) Foreign Application Priority Data
Aug. 1, 2019 (EP) 19382669.0

(51) Int. Cl. E04F 10/06; F21S 4/20; F21V 23/00; F21V 33/00

(52) U.S. Cl. CPC E04F 10/0666; F21S 4/20; F21Y 2115/10; F21V 33/006; E04F 10/0611; F21V 23/002

(57) ABSTRACT

An articulated arm structure for an awning with an integrated electrical installation relates to an articulated arm structure for an awning, of the type designed to have an integrated electrical installation, mainly of LED (Light Emitting Diodes) lighting, but also of electrical wiring to supply any device requiring electrical energy for its operation, and has a series of improvements which, among others, provides advantages of ease of assembly, enlargement of the lit-up area and improved aesthetics.

### OBJECT OF THE INVENTION

The present invention, an articulated arm structure for an awning with an integrated electrical installation, relates to an articulated arm structure for an awning, of the type designed to have an integrated electrical installation, mainly of LED (Light Emitting Diodes) lighting, but also of electrical wiring to supply any device requiring electrical energy for its operation, has a series of improvements which, among others, provides advantages of ease of assembly, enlargement of the lit-up area and improved aesthetics.

The field of application of the present invention is comprised within the sector of the industry dedicated to the manufacture of awnings, particularly focusing on the field of the manufacture of structures supporting them and, in particular, those incorporating electrical installation and LED lighting systems.

### BACKGROUND OF THE INVENTION

European patent document EP15382014 relates to an articulated arm structure for an awning with integrated lighting comprising articulated awning arms with channels in the profiles for incorporating LED lighting strips, lids in the elbows to cover the wires, and conduits at the ends for the wires, solving the problems entailed in the use of lighting systems, specifically LED type lighting systems, incorporated in the awnings, specifically in the articulated arms which ensure the extension and folding of the canvas of the roller awning with respect to a shaft, because, when the LED strips are incorporated in said arms, the latter are joined to each other by a section of wiring which must have sufficient slack to allow the mobility and rotation of the joint or “elbow” joining both segments of the arm, which, in addition to being unsightly, makes said section of wiring susceptible of being pinched or rubbed during the opening and closing operations of the awning. Furthermore, said structure allows including a lid incorporated in the same profile, preferably translucent, which covers the LED strips for the purpose of softening the light, solving the glare problem which they may cause.

Thus, although the mentioned structure satisfactorily achieves the objectives with which it was designed, it has certain aspects that can be improved. Specifically, one of said aspects is the ease of assembly, as well as the aesthetic appearance, since the “wire protector” parts are fixed to the elbows of the joint by means of screws, whereby in addition to it being necessary to use a tool for their installation and removal, they are a visible element which can make the assembly unsightly, especially if they get rusty or dirty.

Another aspect to be improved is the complexity of the structural configuration of said wire protector parts, since the crown-shaped protrusion it has on its inner face for fitting into the complementary slots of the center of the joint, in addition to being an element which complicates the shape of the part, can be an obstacle for guiding the wire when opening-closing, being able to collide with the wire upon inserting the wire protector in the rear profile.

Finally, a last aspect to be improved is the lighting area of the LED strips, since the connectors joining said strips with the wires linking them to each other, in the known structure are placed in the housings of the profiles, and therefore occupy a space thereof which is not lit up.

The objective of the present invention is therefore to provide an improved articulated arm structure for an awning with an integrated electrical installation, either LED strip integrated lighting or electrical wiring integrated lighting, of the type extending from the box of the awning to the load bar, to supply a lighting, a curtain motor, a heater, loudspeakers, or any device requiring electrical energy for its operation.

### DESCRIPTION OF THE INVENTION

The object of the present invention is an articulated arm structure for an awning with an integrated electrical installation according to claim 1.

More specifically, the invention proposes an articulated arm structure for an awning, of the type configured from respective straight profiles, a front one and a rear one, which are joined to each other by means of an articulated joint, forming an arm which, in combination with another arm, allows opening and closing an awning, the canvas of which is rolled on a shaft, by means of the movement of a load bar located at an end of the arms, whereas at the other end the rolling shaft of the canvas is located. The structure has, in the elbows of said joint between both profiles, with respective wire protector guiding parts, a wire protector female part and another wire protector male part which fit respectively on the female and male elbows of the joint, concealing and guiding a section of wiring between the two profiles configuring each arm, thus ensuring the passage thereof integrated in the joint in its movements of articulation with the profiles, i.e., in the opening and closing of the awning. Said section of wire can form part either of an integrated system of lighting with LED strips, in which case the profiles have longitudinal grooves determining housing for said strips, or only of electrical wiring passing from one end to another of the arms to supply a device located in the load bar. Specifically, both wire protector parts are fixed to the respective elbows by means of a clip part which embraces each wire protector part and is clipped, fitted or coupled, at its respective ends, with the side of the elbow, such that once said clip part is fixed, it is integrated flush between both parts, the elbow and the wire protector part. The dimensions of the clip parts will depend on the dimensions of the wire protector parts, each clip part being able to be identical or different to the other clip part.

Thus, the assembly of the wire protector parts is facilitated and at the same time the aesthetic appearance of the arm is improved, since said wire protector part instead of being fixed to the elbows of the joint by means of screws inserted through holes made therein for that purpose, are fixed by means of said clip part embracing the wire protector, preferably in a slot thereof, and is clipped, fitted or coupled, at both ends in the elbow, such that once said clip part is fixed, it is integrated in both parts mechanically and aesthetically.

Additionally, the arm structure of the present invention has a greater simplicity in the configuration of the wire protector parts, particularly the female wire protector part which fits in the female elbow of the joint, the inner face of which is smooth and free of any protrusion, unlike the parts of the state of the art which were crown/shaped to fit in the center of said elbow, since it is not necessary for its fixing and allows there to be no element which can collide with the wire.

Likewise, the arm structure of the present invention has a foot or projection extending on the side of the male wire protector part to be inserted or introduced in a cavity of the front profile, preventing it from being separated from the male elbow. In the same way, the female wire protector has two similar feet or projections which are fitted in respective cavities of the rear profile so that it cannot be separated from the female elbow.

Likewise, the arm structure of the present invention can have both elbows, male and female, of the joint with respective notches in the exit area of the wires, thus allowing increasing the available space between them and the corresponding wire protector parts to place in them the connectors joining them to the LED strips.

Thus, the advantages provided by this awning arm structure object of the present invention are essentially the following:
Simpler assembly, because the assembly/disassembly is carried out by hand, without needing a screwdriver,
The LED strip can reach up to the end of the housing of the profile provided to that end, because the connector which it has at its end can now be housed between the wire protector and the elbow, thus eliminating dark areas in the translucent cover covering said LED and allowing it to be lit up in its entire length, and
Improved aesthetics, because the clip is integrated in the wire protector-elbow assembly.

### DESCRIPTION OF THE DRAWINGS

To complete the description of the present invention and for the purpose of facilitating the understanding of the features thereof, a set of illustrative and non-limiting figures is attached.

FIG. 1 shows a perspective view of a first embodiment of the structure object of the invention, specifically an example with grooves for an integrated LED lighting electrical installation, having only depicted a portion thereof which, in any case, allows observing the main parts and elements which it comprises, as well as its configuration and arrangement.

FIG. 2 shows a perspective view of the structure of the invention very similar to that shown in the previous figure, in this case depicted with the profiles without including the cover of the LED strips and with the joint without including the wire protector parts coupled in the elbows thereof.

FIG. 3 shows a top plan view of the portion of structure of the invention, according to the example shown in FIGS. 1 and 2, in this case including the LED strips with the connectors and the wire joining it incorporated, respectively, in the profiles and in the joint.

FIGS. 4 and 5 shows respective perspective views of another embodiment of the structure of the invention, specifically an example for integrating an installation of only electrical wiring, depicted respectively with and without the partition covering the grooves of the profiles and the wire protector parts of the elbows.

And FIGS. 6 and 7 respectively show top and bottom perspective views of the male and female wire protector parts and their respective fixing clips.

### PREFERRED EMBODIMENT OF THE INVENTION

Non-limiting examples of the articulated arm structure for an awning of the invention are described below with reference to the figures, which structure comprises the parts and elements which are indicated and described in detail below.

Thus, as can be seen in said figures, the structure (1) in question is configured from respective straight profiles, a front one (2) and another rear one (2′) which are joined in a joint of respective male (3) and female (3′) elbows, forming and articulated arm which, in combination with another one, allows opening and closing a rolling canvas awning (not shown), wherein said elbows (3, 3′) respectively incorporate respective male (6) and female (6′) wire protector guiding parts which, having a concordant configuration, fit onto the same, concealing and guiding a section of wiring (5) existing between the two profiles (2, 2′), ensuring the passage thereof integrated in the joint in its movements of articulation, i.e., in the opening and closing of the awning, which wire (5) forms part of an integrated installation, which can be of lighting with LED strips (4), or only of electrical wiring passing from one end to another of profiles (2, 2′), inserted in longitudinal grooves determining housings (13).

And, from this already known configuration, the structure (1) is essentially distinguished in that each wire protector part (6, 6′) is fixed to the respective elbow (3, 3′) by means of a clip part (7) which, with a C-shaped configuration, embraces the wire protector (61, 62), fitting in a slot (8) thereof and clips at its respective ends (71) into the side of the elbow (3, 3′), specifically fitting in recesses (10) provided on both sides of the elbows (3, 3′) for that purpose, such that, once said clip part (7) is fixed, it is integrated flush between both parts, the elbows (3, 3′) and the wire protector parts (6, 6″). The dimensions of the clip parts (7) will depend on the dimensions of the wire protector parts (6, 6″), each clip part (7) being able to be identical or different to the other clip part (7).

Furthermore, the female wire protector part (6′) fitting in the female elbow (3′) of the joint, has an inner face which is smooth and free of protrusions to fit in the center of said elbow, allowing the passage of the section of wire (5) thereon without there being any obstacle to the passage thereof.

Likewise, both wire protector parts (6, 6′) have fixing feet (11) extending on the side thereof to fit in cavities (12) of the profiles (2, 2′), preventing them from being separated from the corresponding elbows (3, 3′).

More specifically, the male wire protector (6) has a side foot (11) which extends to be inserted in a cavity (12) of the front profile (2), preventing it from being separated from the male elbow (3). And the female wire protector (6′) has two side feet (11) which extend to be fit in respective cavities (12) of the rear profile (2′), preventing it from being separated from the female elbow (3′).

Preferably, said feet (11) extend on the side of the wire protector parts (6, 6′) determined by a planar face (9) located behind the slot (8) for the insertion of the clip part (7), which faces the end of the corresponding profile (2, 2′).

Likewise, in an embodiment wherein the structure (1) incorporates an integrated installation of lighting with LED strips (4), both elbows, male (3) and female (3′), of the joint have respective notches (15) which allow increasing the available space between them and the corresponding wire protector parts (6, 6′), to place in them the connectors (16) joining the LED strips (4) with the section of wire (5) which joins them and is placed on said joint. Said connector (16) has a larger section than the LED strip (4) and than the wire (5), because it embraces both of them.

At the same time, the slots (8) for the insertion of the clips (7) in the wire protectors (6, 6′), define respective windows enlarging the mentioned space for the inclusion of the connectors (16) of the LED strips (4).

As a result of said space increases, the connector (16) can be located between the wire protector (6, 6′) and the elbow (3, 3′) (instead of inside the housing (13) of the profile (2, 2′) under the cover (14)), whereby it is achieved that the LED strip (4) can have the same length as the profile (2, 2′), achieving it to be lit up in its entire length.

It must be indicated that the described structure (1) is preferably designed such that, upon introducing the wire protector (6, 6′) in the profile (2, 2′) and on the corresponding elbow (3, 3′), the following occurs:
the feet (11) of the wire protectors (6, 6′) enter the cavities (12) of the profiles (2, 2′) with reduced clearance,
the inner face of the wire protector (6, 6′) fits in its entire perimeter onto the outer face of the elbow (3, 3′),
the wire protector (6, 6′) has a planar face (9) resting on the planar face of the end of the profile (2, 2′).

Therefore, at that time, the wire protector (6, 6′) can only move in the direction of the main axis of the profile (2, 2′), which is the direction needed to introduce the feet (11) in the cavities (12) of the profile (2, 2′).

In turn, said movement capacity is annulled upon incorporating the clip (7) since it fits simultaneously in the slots (8) of wire protectors (6, 6′) aligned at the recesses of the elbows (3, 3′), which are transverse to the axis of the profile.

The clipping of both ends (71) of the clip (7) has two functions:
maintain the clip (7) inserted in said slots (8), e
preventing the wire protector (6, 6′) from being separated from the elbow (3, 3′) because of the small clearances between the feet (11) and the cavities (12) of the profile (2, 2′), necessary for being able to perform the assembly movement.

In an alternative embodiment, the structure (1) contemplates that the profile (2, 2′) and the clip (7) of one of both elbows (3, 3′), preferably in the female wire protector (6′), are more separated from one another, to enlarge the fastening base preventing the wire protector (6, 6′) from being separated from the elbow (3, 3′), which base is formed by the feet (11) and the clips (7) of both wire protectors (62, 61).

To that end, the slot (8) of the female wire protector (6′), instead of being parallel to the edge of the end of the profile (2′), is oblique to the edge, or forming a curve in accordance with the curve of the female elbow (3′).

In another embodiment, the female wire protector (6′) incorporates two clips (7) and a V- or Y-shaped slot (8).

In addition, in one embodiment, the cavities (12) of the profile (2, 2′) in which the feet (11) of the wire protectors (6, 6′) enter, are an extension of the longitudinal grooves determining the housings (13), without being separated by a partition.

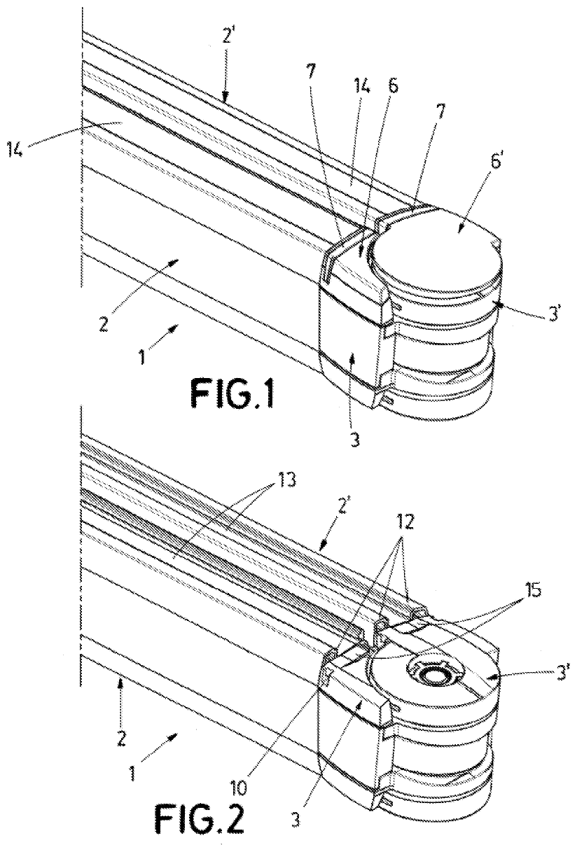

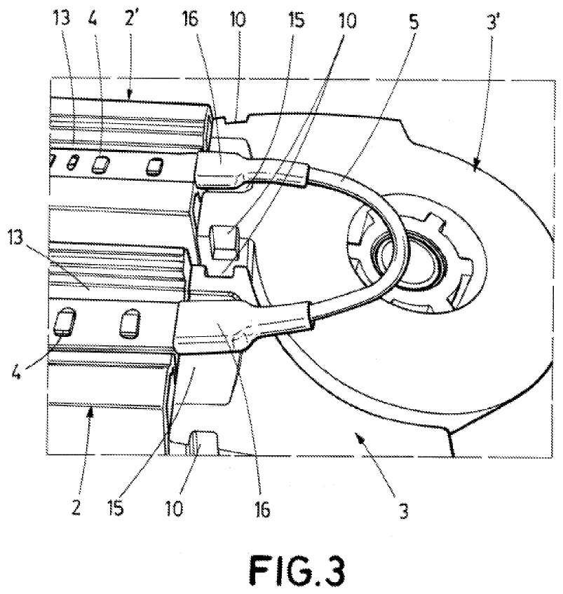

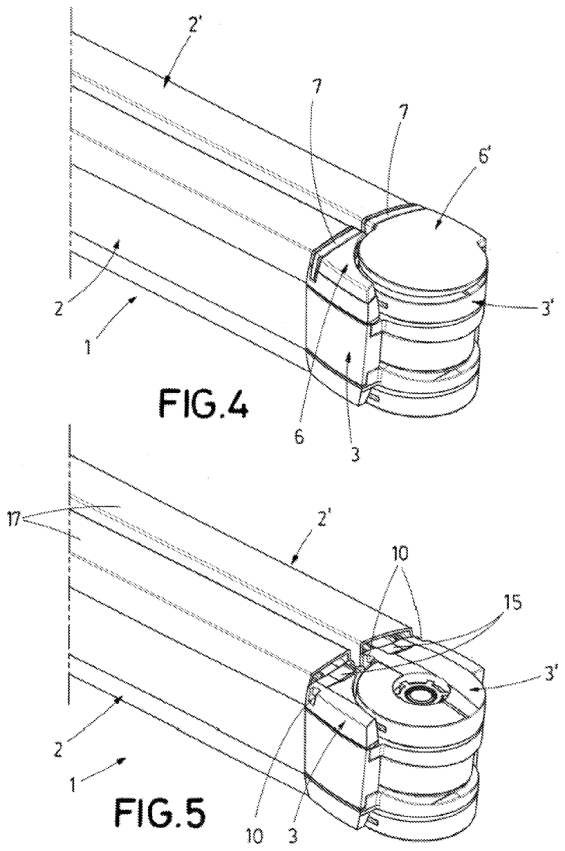

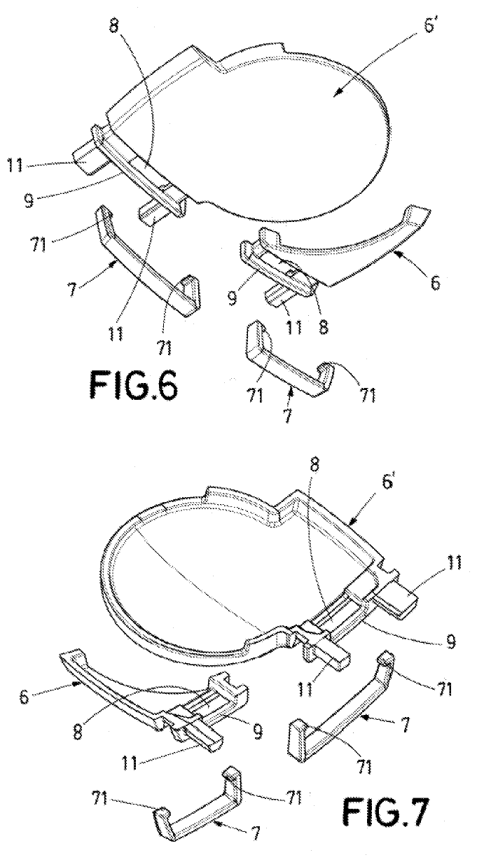

Finally, when the structure (1) incorporates an integrated installation of lighting with LED strips (4), inserted in the housings (13), these are covered with transparent or translucent covers (14), as can be observed in FIGS. 1 and 2. And, when it incorporates and integrated installation of only electrical wiring passing from one end to another of profiles (2, 2′), said housings (13), as can be observed in FIGS. 3 and 4, are covered by an aluminium partition (17). The resulting inner channel serves to house the wires conducting electricity from one end to another of the arm, to supply accessories in the load bar of the awning (motor of a curtain, light, heating, sound, etc.). In any case, the wire protectors (6, 6′) and clips (7) perform the same function as in the preferred configuration: covering the wires in their passage through the elbows.

1. An articulated arm structure for an awning with an integrated electrical installation, of the type configured from respective straight profiles, a front one and another rear one which are joined to each other in an articulated joint of respective male and female elbows, forming an articulated arm which, in combination with another one, allows opening and closing an awning with a canvas which can be rolled on a shaft, wherein said elbows incorporate respective wire protector guiding parts, a male part and a female part which fit on the elbows, concealing and guiding a section of wiring existing between said two profiles, said wiring forming part of an integrated installation, of lighting with LED strips of or only of electrical wiring passing from one end to another of the profiles, said installation being inserted in longitudinal grooves determining housings, wherein each wire protector part is fixed to the respective elbow by means of a clip part which embraces each wire protector part and is clipped at its respective ends with the side of the elbow, such that once said clip part is fixed, it is integrated flush between both parts, the elbow and the wire protector part.

2. The structure according to claim 1, wherein the female wire protector part fitting in the female elbow of the joint, has an inner face which is smooth and free of protrusions to fit in the center of said elbow, allowing the passage of the section of wire thereon without there being any obstacle to the passage thereof.

3. The structure according to claim 1, wherein both wire protector parts have fixing feet extending on the side thereof to fit in cavities of the profiles, preventing them from being separated from the corresponding elbows.

4. The structure according to claim 1, wherein the clip parts have a C/shaped configuration embracing the wire protector parts, fitting in a slot thereof and clipping at their respective ends in respective recesses provide don both sides of the elbows.

5. The structure according to claim 1, wherein the male wire protector part has a side foot which extends to be inserted in a cavity of the front profile, preventing it from being separated from the male elbow.

6. The structure according to claim 1, wherein the female wire protector part has two side feet which extend to fit in respective cavities of the rear profile, preventing it from being separated from the female elbow.

7. The structure according to claim 1, wherein the feet extend on a side of the wire protector parts determined by a planar face located behind the slot for the insertion of the clip part, which faces the end of the corresponding profile.

8. The structure according to claim 1, wherein both elbows, the male one and the female one, have respective notches which allow increasing the available space between them and the corresponding wire protector parts, to place in them the connectors joining the LED strips with the section of wire which joins them and is placed on said joint.

9. The structure according to claim 1, wherein the slots for the insertion of the clips in the wire protectors define respective windows enlarging the space between them and the elbows for the inclusion of the connectors of the LED strips.

10. The structure according to claim 1, wherein the LED strip has approximately the same length as the profile.

11. The structure according to claim 1, wherein both clip parts have the same dimensions.

12. The structure according to claim 1, wherein both clip parts have different dimensions.
